(19) United States
(12) Patent Application Publication
(10) Pub. No.: US 2026/0214759 A1
(43) Pub. Date: Jul. 23, 2026

(54) TRANSPARENT DIELECTRIC HEATER COMPOSITION AND TRANSPARENT DIELECTRIC HEATER

(71) Applicant: Korea University of Technology and Education Industry-University Cooperation Foundation, Cheonan-si (KR)

(72) Inventors: Jin Woo BAE, Seoul (KR); Seung Eun CHOI, Cheonan-si (KR); Seung Ju OH, Cheonan-si (KR)

(73) Assignee: Korea University of Technology and Education Industry-University Cooperation Foundation, Cheonan-si (KR)

(21) Appl. No.: 19/577,149

(22) Filed: Mar. 24, 2026

Related U.S. Application Data
(63) Continuation of application No. PCT/KR2025/017818, filed on Nov. 3, 2025.

(30) Foreign Application Priority Data
Nov. 4, 2024 (KR) 10-2024-0154333

(51) Int. Cl. H05B 6/46; C08F 114/06; C08K 5/11; C08K 5/12

(52) U.S. Cl. CPC H05B 6/46; C08F 114/06; C08K 5/11; C08K 5/12

(57) ABSTRACT

The present invention relates to a transparent dielectric heater composition and a dielectric heater. In an embodiment, PC and EC are added to impart high performance and high flexibility. A dielectric heater composition according to an embodiment of the present invention includes a polymer resin, a main plasticizer, and propylene carbonate (PC), and ethylene carbonate (EC).

### CROSS-REFERENCE TO RELATED APPLICATION

This application is a continuation application under 35 U.S.C. § 111(a) of International Patent Application No. PCT/KR2025/017818, filed Nov. 3, 2025, which claims priority to Korean Patent Application No. 10-2024-0154333, filed Nov. 4, 2024, the entire contents of each of which are incorporated herein by reference.

### BACKGROUND

The present disclosure relates to a transparent dielectric heater composition and a transparent dielectric heater. In an embodiment, PC and EC are added to impart high performance and high flexibility.

The present invention is the result of research conducted with the support of the National Research Foundation of Korea under the funding of the Ministry of Science and ICT (RS-2024-00348475).

Flexible transparent heaters use technology of providing high thermal conduction performance through electrical heat generation while maintaining a thin and flexible structure. Such heaters can be used in various fields such as electronic devices, displays, and wearable devices, and their transparent and flexible properties are particularly useful in applications such as displays and touch screens.

Conventional flexible transparent heater technology mainly uses materials such as metal nanowires, carbon nanotubes (CNTs), and graphene to form a transparent electrode, and then manufactures a heater based on the electrode. Although this approach provides excellent electrical properties, metal nanowires and carbon nanotubes are expensive, have low transparency, and experience performance degradation due to decreased resistance caused by mechanical deformation. Particularly, there is a problem in that it is difficult to achieve uniform heat distribution. In addition, due to insufficient durability caused by mechanical deformation, performance may degrade over a long-term use.

Particularly, plasticizers used in conventional technology are mainly materials such as dioctyl sebacate (DBA), and dielectric layers using these plasticizers are effective in imparting flexibility, but have relatively poor dielectric performance. This problem leads to degradation in thermal conduction performance of flexible heaters, thereby causing an increase in power consumption, or prevents a sufficient amount of heat from being provided, thereby limiting practical applications.

### SUMMARY

The present disclosure provides a dielectric heater composition capable of manufacturing a dielectric heater with high transparency.

The present disclosure also provides a dielectric heater with excellent dielectric properties.

In addition, the dielectric heater provided by the present disclosure has excellent heater performance and thermal stability.

In accordance with an exemplary embodiment of the present invention, a dielectric heater composition includes a polymer resin, a main plasticizer, and propylene carbonate (PC), and ethylene carbonate (EC).

A content ratio of the polymer resin to the sum of the main plasticizer, the propylene carbonate, and the ethylene carbonate may be 1:5.5 to 1:6.5 on a weight basis.

A content ratio of the main plasticizer to the sum of the propylene carbonate and the ethylene carbonate may be 2.5:1 to 3.5:1 on a weight basis.

A content ratio of the propylene carbonate to the ethylene carbonate may be 1:8.5 to 1:9.0 on a weight basis.

A content ratio of the polymer resin to the main plasticizer may be 1:4 to 1:5 on a weight basis.

A content ratio of the polymer resin to the sum of the propylene carbonate and the ethylene carbonate may be 1:1 to 1:2 on a weight basis.

In accordance with another exemplary embodiment of the present invention, a method for manufacturing a dielectric heater layer includes dissolving a polymer resin in a solvent to prepare a polymer resin solution, mixing the polymer resin solution with a main plasticizer, propylene carbonate, and ethylene carbonate to prepare a mixture, and drying the mixture.

A content ratio of the polymer resin to the sum of the main plasticizer, the propylene carbonate, and the ethylene carbonate added in the preparing of a mixture may be 1:5.5 to 1:6.5 on a weight basis.

In accordance with another exemplary embodiment of the present invention, a dielectric heater includes the dielectric heater layer described above.

### BRIEF DESCRIPTION OF THE DRAWINGS

Exemplary embodiments can be understood in more detail from the following description taken in conjunction with the accompanying drawings, in which:

FIG. 1 is a flowchart of a method for manufacturing a transparent dielectric heater in accordance with an exemplary embodiment of the present invention;

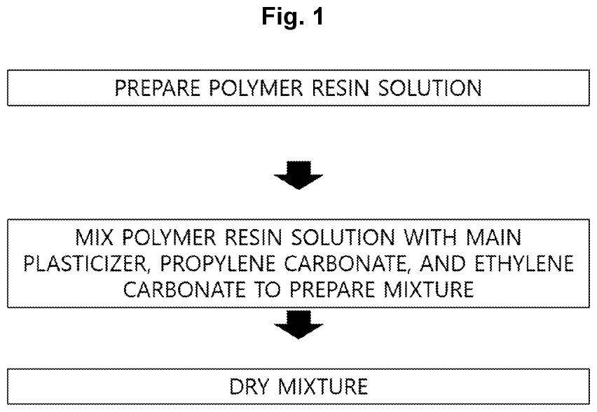

FIG. 2 illustrates the result of measuring the dielectric constant of a dielectric heater layer;

FIG. 3 illustrates the result of measuring the dielectric constant of a dielectric heater layer in accordance with another exemplary embodiment;

FIG. 4 shows the result of analyzing the loss factor of a dielectric heater layer;

FIG. 5 shows the result of analyzing the stress-strain curve of a dielectric heater layer in accordance with another exemplary embodiment;

FIG. 6 shows the result of measuring the thermal decomposition temperature.

FIG. 7 shows the result of measuring the transmittance of a dielectric heater layer, a gel electrode, etc.;

FIG. 8 shows captured photographs showing temperature changes according to an applied voltage and stretching of a dielectric heater; and

FIG. 9 is a graph showing temperature changes over time according to an applied voltage and stretching of a dielectric heater.

### DETAILED DESCRIPTION OF EMBODIMENTS

Hereinafter, preferred embodiments of the present invention will be described as follows with reference to the accompanying drawings. However, embodiments of the present invention may be modified into various other forms, and the scope of the present invention is not limited to the embodiments described below. In addition, the embodiments of the present invention are provided in order to more fully describe the present disclosure to those with average knowledge in the art.

In accordance with an exemplary embodiment of the present invention, a dielectric heater composition includes a polymer resin, a main plasticizer, and propylene carbonate (PC), and ethylene carbonate (EC).

The polymer resin serves as a substrate of a dielectric heater. The polymer resin acts as an electrical insulator, thereby providing stability in a process of converting electrical energy into heat energy, and imparts flexibility, thereby allowing use in various application environments. In addition, the polymer resin improves thermal conductivity. In addition, the polymer resin has high heat resistance, thereby maintaining physical and chemical properties thereof even when used for a long period of time, and maintains performance of a heater stable.

The polymer resin may be polyvinyl chloride (PVC), polyurethane (PU), polysiloxane (silicone resin), polyethylene terephthalate (PET), or the like, and may preferably be polyvinyl chloride.

The main plasticizer improves mechanical properties of the polymer resin, and makes the material more flexible, thereby improving processability and workability. Preferably, the main plasticizer may be dibutyl adipate (DBA).

A content ratio of the polymer resin to the main plasticizer may be 1:4 to 1:5 on a weight basis. If the content of the main plasticizer is low, there is a problem in that flexibility and mechanical properties are reduced, whereas if the content is too high, there is a problem in that mechanical strength is degraded and heat resistance is degraded.

The propylene carbonate (PC) and the ethylene carbonate (EC) function as auxiliary plasticizers. The propylene carbonate and the ethylene carbonate act together with the main plasticizer, thereby improving flexibility of PVC, improving dielectric performance, and increasing thermal stability.

The propylene carbonate serves to improve dielectric performance, thereby strengthening electrical properties. This allows the dielectric heater to generate heat of a higher temperature and use power more efficiently. The propylene carbonate may be represented by Structural Formula 1.

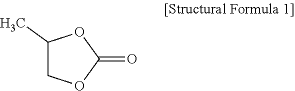

The ethylene carbonate (EC) is a material with a high dielectric constant, and increases the ratio of energy dissipated from electrical energy to heat energy. The ethylene carbonate may be represented by Structural Formula 2.

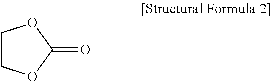

A content ratio of the propylene carbonate to the ethylene carbonate may be 1:8.5 to 1:9.0 on a weight basis. If the content of the propylene carbonate is high, there is a problem in that dielectric properties are deteriorated and mechanical strength is degraded, whereas if the content of the ethylene carbonate is high, there is a problem in that flexibility is degraded.

A content ratio of the polymer resin to the sum of the main plasticizer, the propylene carbonate, and the ethylene carbonate may be 1:5.5 to 1:6.5 on a weight basis, and a content ratio of the polymer resin to the sum of the propylene carbonate and the ethylene carbonate may be 1:1 to 1:2 on a weight basis, preferably 1:1.5 to 1:1.7. If the content of the sum of the main plasticizer, the propylene carbonate, and the ethylene carbonate is high, dielectric properties are improved, but there is a problem in that mechanical properties are deteriorated since a large amount of plasticizer is included, whereas if the content is low, dielectric properties are not improved.

A content ratio of the main plasticizer to the sum of the propylene carbonate and the ethylene carbonate may be 2.5:1 to 3.5:1 on a weight basis. If the content of the sum of the propylene carbonate and the ethylene carbonate is too high, making the content of the main plasticizer to be 50% or greater on a weight basis, water is generated in a manufactured dielectric heater layer, thereby reducing dielectric performance, whereas if the content is low, dielectric properties are not improved.

In accordance with another exemplary embodiment of the present invention, a method for manufacturing a dielectric heater layer includes dissolving a polymer resin in a solvent to prepare a polymer resin solution, mixing the polymer resin solution with a main plasticizer, propylene carbonate, and ethylene carbonate to prepare a mixture, and drying the mixture.

In the dissolving of a polymer resin in a solvent to prepare a polymer resin solution, the polymer resin is as described above, and the solvent may be an organic solvent capable of dissolving the polymer resin. Preferably, the solvent may be tetrahydrofuran (THF). The present step may be performed at room temperature, and a sufficient amount of solvent may be used so as to dissolve the polymer resin.

In the preparing of a mixture, each component is as described above, and the content of each component added in the present step is also the same as described above. The present step may be performed by adding each component to a stirrer and then stirring the same.

The drying of the mixture may be performed by pouring the mixture into a mold, a petri dish, or the like, and drying the solvent by applying room temperature or a constant temperature.

In accordance with another exemplary embodiment of the present invention, a dielectric heater includes the dielectric heater layer described above. The dielectric heater may further include components such as an electrode in contact with the transparent dielectric heater layer.

### Experiments for Optimizing Content Ratio of PC:EC

### EXAMPLES: PREPARATION OF DIELECTRIC AUXILIARY PLASTICIZER

Example 1 (PC:EC 1:9): 9 g of ethylene carbonate (DAEJUNG) was added to 1 g of propylene carbonate (Sigma Aldrich), and subjected to ultrasonic treatment (sonication) for 30 minutes.

Example 2 (PC:EC 1:7): Preparation was performed in the same manner as in Example 1, except that 1 g of PC and 7 g of EC were added.

Example 3 (PC:EC 1:5): Preparation was performed in the same manner as in Example 1, except that 1 g of PC and 5 g of EC were added.

Example 4 (PC:EC 1:3): Preparation was performed in the same manner as in Example 1, except that 1 g of PC and 3 g of EC were added.

Example 5 (PC:EC 1:1): Preparation was performed in the same manner as in Example 1, except that 1 g of PC and 1 g of EC were added.

In manufacturing a dielectric heater layer, if the content of EC was greater than nine times that of PC, the PC and the EC did not dissolve. Therefore, the content ratio of PC to EC was set to a maximum of 1:9.

### Experimental Example: Measurement of Dielectric Constant

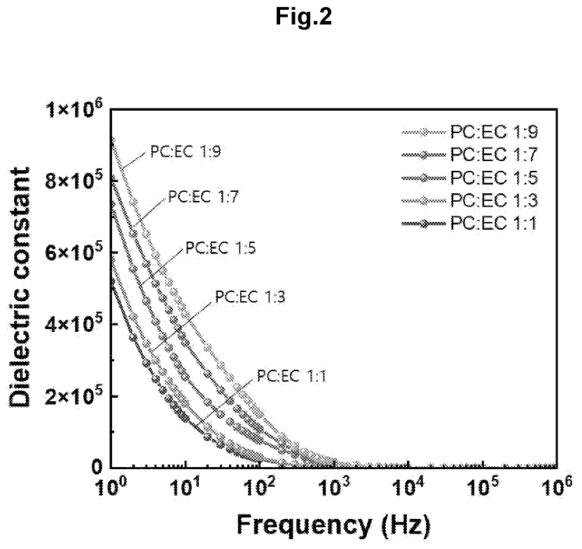

Dielectric constants of Examples 1 to 5 were measured using an impedance analyzer of Solartron Co., and the results are shown in FIG. 2.

Referring to FIG. 2, it can be seen that the dielectric constant of Example 1 is the most excellent.

### Experiments for Optimizing Content Ratio of Main Plasticizer: PC and EC

### EXAMPLES: MANUFACTURING OF DIELECTRIC HEATER LAYER

Example 6 (D-PE6(6:0)): 0.8787 g of PVC powder (Scientific Polymer Products, Inc., Mw 275,000) was dissolved in 50 mL of tetrahydrofuran to prepare a PVC solution. 5.2722 g of DBA (TCI), 0 g of PC (Sigma Aldrich), and 0 g of EC (DAEJUNG) were added to the PVC solution, and subjected to ultrasonic treatment (sonication) for 30 minutes. The mixture was poured into a petri dish and subjected to solution casting to remove the solvent, thereby manufacturing a dielectric heater layer.

Example 7 (D-PE6(6:1)): Preparation was performed in the same manner as in Example 6, except that 1.0125 g of PVC, 5.0627 g of DBA, 0.1012 g of PC, and 0.9113 g of EC were added.

Example 8 (D-PE6(6:2)): Preparation was performed in the same manner as in Example 6, except that 1.0960 g of PVC, 4.9321 g of DBA, 0.1096 g of PC, and 0.9864 g of EC were added.

Example 9 (D-PE6(6:3)): Preparation was performed in the same manner as in Example 6, except that 1.1966 g of PVC, 4.7795 g of DBA, 0.1194 g of PC, and 1.0750 g of EC were added.

### Experimental Example: Measurement of Dielectric Constant

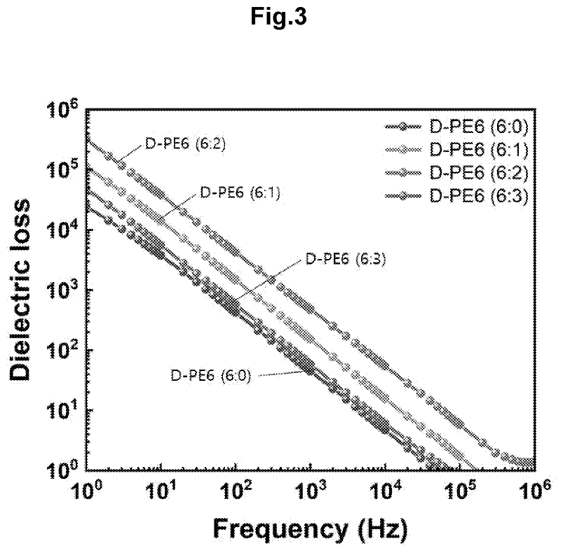

Dielectric constants of Examples 6 to 9 were measured in the same manner as described above, and the results are shown in FIG. 3.

Referring to FIG. 3, it can be seen that the dielectric constant of Example 8 is the most excellent. For reference, in Example 9, it is determined that water was generated in the dielectric heater layer, resulting in reducing dielectric properties.

### Experiments for Optimizing Content Ratio of Polymer Resin: Main Plasticizer, PC, and EC

### EXAMPLES: MANUFACTURING OF DIELECTRIC HEATER LAYER

Example 10 (D-PE2): 2.1687 g of PVC powder (Scientific Polymer Products, Inc., Mw 275,000) was dissolved in 100 mL of tetrahydrofuran to prepare a PVC solution. 4.3684 g of DBA (TCI), 0.2169 g of PC (Sigma Aldrich), and 1.9518 g of EC (DAEJUNG) were added to the PVC solution, and subjected to ultrasonic treatment (sonication) for 30 minutes. The mixture was poured into a petri dish and subjected to solution casting to remove the solvent, thereby manufacturing a dielectric heater layer.

Example 11 (D-PE4): Preparation was performed in the same manner as in Example 10, except that 1.4561 g of PVC, 4.3684 g of DBA, 0.1456 g of PC, and 1.3105 g of EC were added.

Example 12 (D-PE6): Preparation was performed in the same manner as in Example 10, except that 1.0960 g of PVC, 4.9321 g of DBA, 0.1096 g of PC, and 0.9864 g of EC were added.

Example 13 (D-PE8): Preparation was performed in the same manner as in Example 10, except that 0.8787 g of PVC, 5.2722 g of DBA, 0.0879 g of PC, and 0.7908 g of EC were added.

### Experimental Example: Measurement of Dissipation Factor

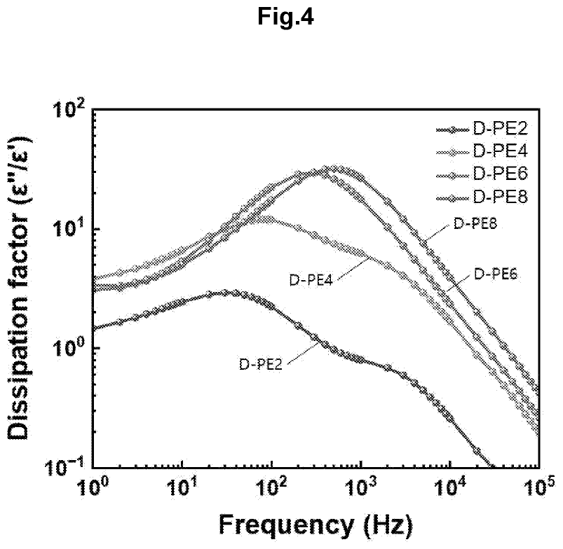

Dissipation factors of Examples 10 to 13 were measured using an impedance analyzer of Solartron Co., and the results are shown in FIG. 4.

Referring to FIG. 4, Examples 12 and 13 exhibited high dissipation factors, and thus can be seen as suitable for a dielectric heater which require high dielectric properties.

### Experimental Example: Analysis of Stress-Strain Curve

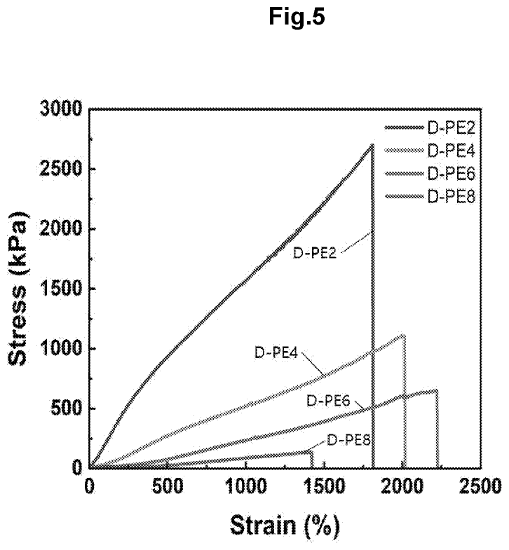

Stress-strain of Examples 10 to 13 was analyzed in the same manner as described above, and the results are shown in FIG. 5.

Referring to FIG. 5, it can be seen that Example 12 has the most excellent mechanical properties, whereas Example 13 has significantly poor mechanical properties.

### Experimental Example: Measurement of Pyrolysis Temperature

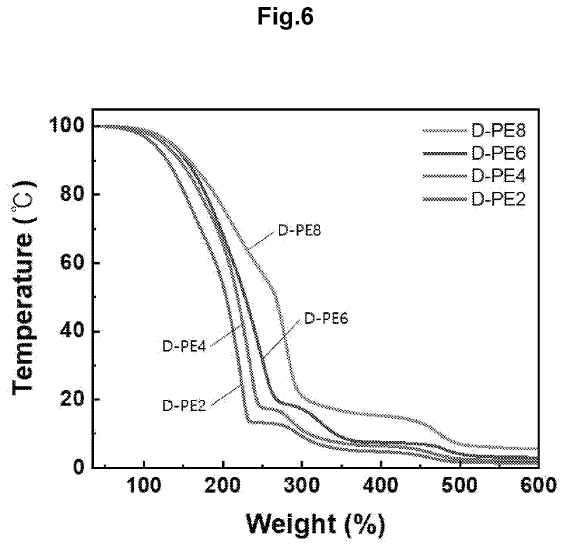

Pyrolysis temperatures of Examples 10 to 13 were measured using a TGA 4000 of Perkin Elmer Co., and the results are shown in FIG. 6.

Referring to FIG. 6, the pyrolysis temperature was 200° C. to 300° C. in all Examples, and the pyrolysis temperatures of Examples 12 and 13 were particularly high, and thus were confirmed to have no problem of being used as heaters.

### Experimental Example: Measurement of Transmittance

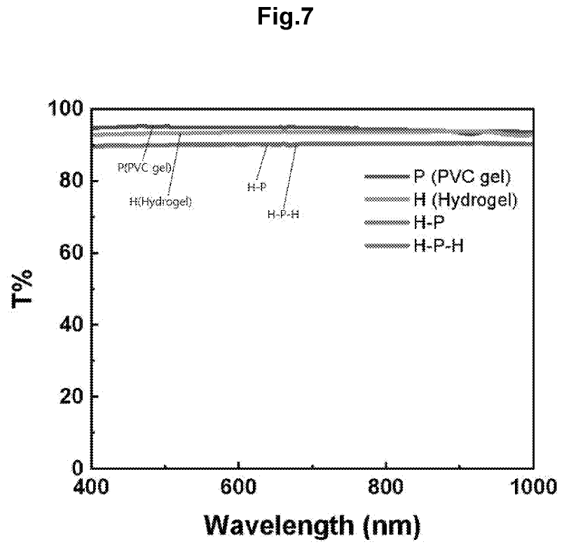

The transmittance of each of Example 12 (P (PVC gel)), a gel electrode (H (Hydrogel)), a laminate (H—P) of Example 12-gel electrode, and a laminate (H—P—H) of gel electrode-Example 12-gel electrode was measured, and the results are shown in FIG. 7.

For reference, the gel electrode was manufactured by adding 1.98 g of acrylic amide, 2.38 g of LiCl, and 0.0021 g of N,N′-methylenebisacrylamide to 5.6323 g of distilled water and performing ultrasonic treatment thereon for 30 minutes, followed by adding 0.0056 g of ammonium persulfate and 0.00655 g of tetramethylethylenediamine on ice to slow the speed of curing, and injecting pre-gel into a mold made in advance, curing the pre-gel in a UV curing machine for 10 minutes, and repeating this process in reverse to manufacture a back electrode.

In addition, in order to laminate the dielectric heater layer of Example 12 and the gel electrode, a solution of ethanol and benzophenone mixed in a ratio of 1:9 was spray-coated on one or both sides of the dielectric heater layer, and the gel electrode was disposed thereon.

Referring to FIG. 7, it can be seen that the transmittance is excellent in all subjects.

### Experiments on Properties of Dielectric Heater

### Manufacturing Examples: Manufacturing of Dielectric Heater

A dielectric heater was manufactured using the dielectric heater layer of Example 12. A solution of ethanol and benzophenone mixed in a ratio of 1:9 was spray-coated on both sides of the dielectric heater layer of Example 12, and the gel electrode manufactured above was disposed on each side.

### Experimental Example: Observation of Temperature Changes According to Applied Voltage and Stretching

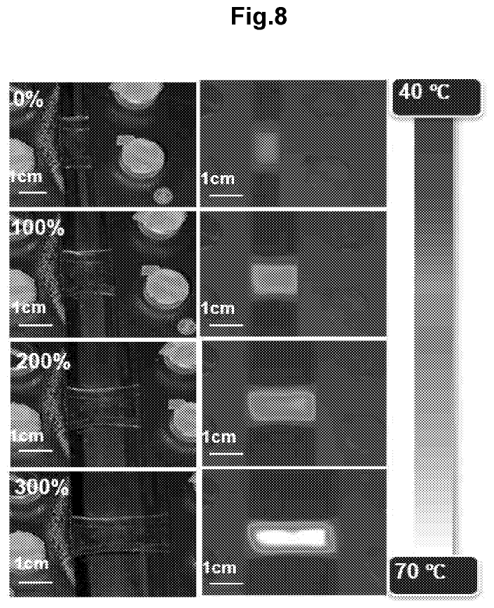

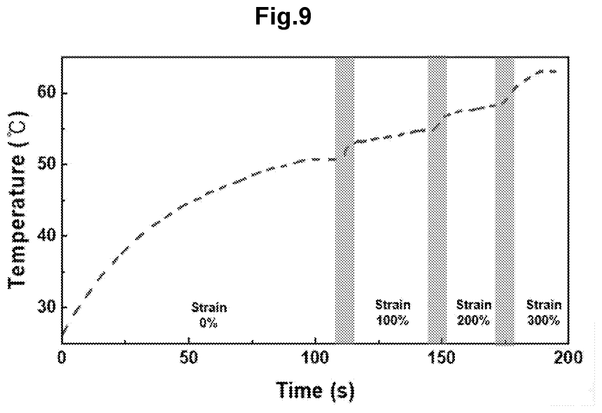

The transparent dielectric heater manufactured in each of Examples was used, and cut to a size of 1 cm²×1 cm² and then stretched from 0% to 300% in increments of 100% under the conditions of 350 Hz and 350 V, and color changes during this process were observed, and the results are shown in FIG. 8 and FIG. 9.

Referring to FIG. 8 and FIG. 9, due to a decrease in thickness of the dielectric layer as a result of the stretched heater, the electric field increased, which also allowed the saturation temperature to increase.

A dielectric heater composition according to an embodiment of the present invention may manufacture a dielectric heater with high transparency.

In addition, a dielectric heater provided by the present invention has excellent dielectric properties.

In addition, the dielectric heater provided by the present invention has excellent heater performance and thermal stability.

The present invention is not limited by the above-described embodiments and the accompanying drawings, but is intended to be limited by the appended claims. Accordingly, various types of substitutions, modifications, and changes may be made by those skilled in the art within the scope not departing from the technical spirit of the present disclosure described in the claims, and these substitutions, modifications, and changes may also belong to the scope of the present disclosure.

What is claimed is:

1. A dielectric heater composition comprising:
a polymer resin;
a main plasticizer;
propylene carbonate (PC); and
ethylene carbonate (EC).

2. The dielectric heater composition of claim 1, wherein a content ratio of the polymer resin to the sum of the main plasticizer, the propylene carbonate, and the ethylene carbonate is 1:5.5 to 1:6.5 on a weight basis.

3. The dielectric heater composition of claim 1, wherein a content ratio of the main plasticizer to the sum of the propylene carbonate and the ethylene carbonate is 2.5:1 to 3.5:1 on a weight basis.

4. The dielectric heater composition of claim 1, wherein a content ratio of the propylene carbonate to the ethylene carbonate is 1:8.5 to 1:9.0 on a weight basis.

5. The dielectric heater composition of claim 1, wherein a content ratio of the polymer resin to the main plasticizer is 1:4 to 1:5 on a weight basis.

6. The dielectric heater composition of claim 1, wherein a content ratio of the polymer resin to the sum of the propylene carbonate and the ethylene carbonate is 1:1 to 1:2 on a weight basis.

7. A method for manufacturing a dielectric heater layer, the method comprising:
dissolving a polymer resin in a solvent to prepare a polymer resin solution;
mixing the polymer resin solution with a main plasticizer, propylene carbonate, and ethylene carbonate to prepare a mixture; and
drying the mixture.

8. The method of claim 7, wherein a content ratio of the polymer resin to the sum of the main plasticizer, the propylene carbonate, and the ethylene carbonate added in the preparing of a mixture is 1:5.5 to 1:6.5 on a weight basis.

9. A dielectric heater comprising the dielectric heater layer of claim 7.
